(19) United States
(12) Patent Application Publication
(10) Pub. No.: US 2017/0201036 A1
(43) Pub. Date: Jul. 13, 2017

(54) COMPOSITE CONNECTOR

(71) Applicant: Dune Medical Devices Ltd., Caesarea (IL)

(72) Inventors: Gil COHEN, Jerusalem (IL); Dan HASHIMSHONY, Pardes Hana (IL); Iddo GELTNER, Even Yehuda (IL); Chen MANN, Kibbutz Merchavia (IL)

(21) Appl. No.: 14/989,887

(22) Filed: Jan. 7, 2016

(51) Int. Cl. H01R 13/00

(52) U.S. Cl. CPC H01R 13/005

(57) ABSTRACT

A composite connector device is provided, comprising a housing having first and second functional sides, the first functional side comprising at least two connection ports of at least first and second different types, and the second functional side comprising at least one connection port of the first type. The composite connector device comprises at least one internal transmission channel passing inside the housing and connecting between the connection ports of said first type at respectively the first functional side and the second functional side of the housing. The composite connector device being, thereby, configured as an adaptor for connection to an external device via the at least one connection port of the first type, and as a connector for connection to an external device via the at least one connection port of said at least second type.

### TECHNOLOGICAL FIELD AND BACKGROUND

This invention is generally in the field of mechanical connectors, and relates to a composite connector, particularly useful in medical applications. Specifically the invention relates to connectors and probes for use in medical devices.

Various medical procedures, including tissue examination and treatment procedures, utilize probe devices, which need to be connected to external systems via transmission lines of different types, and also to be properly attached to a body part. For example, tissue examination in order to characterize it as normal or abnormal, for example as cancerous or non-cancerous, is a known medical procedure. A large number of techniques and sensors are available today for tissue characterization. The sensors may be incorporated into hand-held probes or miniature probes, adapted for contacting with the examined tissue externally, or for insertion into a body lumen or for use in minimally invasive surgery. While the operating principles of different tissue characterization sensors differ, such as ultrasonic, optical or magneto-electric techniques, effective contact between the sensor and the tissue is essential for reliable results in most cases, and is typically implemented by vacuum. The use of suction/negative pressure/vacuum, for engaging a medical instrument to a tissue, is known. Often, such medical examination systems include a relatively large control apparatus including a vacuum system that needs to be connected to a hand-held, relatively small, tissue-characterization probe to provide effective sensor-to-tissue contact.

### GENERAL DESCRIPTION

There is a need in the art for a novel and reliable solution for connection between a control (source) system, often called console, and a probe (a hand-held medical device). Specifically, using such solution for medical devices of the type requiring contact with a tissue/body undergoing examination/treatment, allows at least the “contacting” part of the device, or the entire probe to be sterilized and/or disposable.

There is a need in the art for a novel mechanism of connection between the sterile part of the medical device (or at least connection allowing to keep sterility of that part) with the external control system which may not and practically cannot be kept sterile. Moreover, there is a need for facilitating the use of the control system with replaceable probes, while connection to the probe being in use, is via the sterile part of the probe. To this end, the connection may incorporate disposable parts that ensure the sterility at the side of the probe, e.g. the probe may be sterile and disposable.

The present invention provides a novel composite connector device which includes an adaptor part and a direct connection part to allow for selectively connecting an external console to a medical probe device by coupling at least one transmission channel of the probe to the console via the adaptor, while allowing direct connection of other transmission channel(s) of the probe to the console. In other words, the composite connector device of the invention provides both one-stage (direct) and two-stage (adaptive) connections between the console and the probe for transmission channels of different types.

Considering a medical probe which needs contact with the tissue during operation, the connection between the console and the probe typically includes a fluid-type transmission/communication channel and operative transmission channel(s), e.g. applying one or more external fields to the tissue and/or detecting such field(s) from the tissue, which may be electromagnetic radiation, temperature field, RF, microwave, acoustic, optical, etc. The composite connector of the invention provides for adaptive connection between the console and the probe via fluid-type transmission channel(s) or attachment channel(s) and provides direct connection between the console and probe via other type transmission channels, termed here as “operative transmission channel(s)”, as will be described more specifically further below.

The invention can be used with various types of medical devices and is not limited to any specific probe device, provided the probe device, when operated, needs to communicate with an external console (controller) via different-type transmission channels. Some examples of the medical device of the kind specified include tissue characterization and/or treatment devices described in WO09010960, WO14009893, WO03060462, WO05009200, WO05089065, WO06072947, WO06103665, WO07015255, WO07083310, WO08072238, WO08132714, WO08132750 and WO08104977, all assigned to the assignee of the present application.

The connection mechanism, according to the invention, allows maintaining sterile conditions for at least one of the transmission channels between the console and the probe, while not necessarily requiring such sterile conditions for at least one other-type transmission channel between them, as will be detailed further below.

The novel approach of the invention provides operative communication between the console and a patient, using a disposable and sterile medical probe on one side, and a novel composite connector interconnectable between the probe and the console, on the other side. As will be described below, the connection via the transmission channel that maintains sterile conditions is typically a one-way communication connection, such as in the case of fluid-type transmission channel (e.g. suction). As for the other type transmission channel, being an operation channel, it may be configured for one-way or two-way communication connection, such as the case with electric/magnetic/optical/RF energy transmission. In the latter case, the connection may utilize more than one cable/port for forward and backward transmission. Additional cables/ports may also be used for digital, analog, command and control signal communication between the console and the probe.

As noted above, one type of transmission channel, e.g. vacuum channel, might need to be sterile because it comes with direct contact with the tissue being measured/treated. Another consideration related to a fluid and/or vacuum communication channel is that this channel may become contaminated with body fluids and tissue, requiring that this channel be single-use and disposable.

On the other hand, channels transmitting electrical or RF energy do not need to be sterile as they are not directly contacting the tissue, but rather the sensors on the probe are those that contact the tissue. The sterility of the contact with the tissue can be maintained by the provision of a sterile probe, which for comfort of usage is preferably disposable.

To this end, the novel connection solution, according to the invention, utilizes a composite connector device, which is actually a connector and an adaptor combined. The connector is configured to connect to the console, while the adaptor is configured to receive connection line(s) or transmission channel(s) of the sterile probe, thereby preserving the sterile conditions at the probe side.

The probe, according to the invention, includes a vacuum/fluid connection line/channel integral with and extending directly from the probe towards the adaptor on the composite connector. The other connection lines, e.g. RF connection lines and command and control lines, do not need to be sterile. Therefore, the other connection lines/channels to the probe do not need to be integral with the probe. One possible configuration may be that the probe has connection ports to receive RF and command and control connections, and a vacuum channel fully integrated with the probe and extending therefrom.

Thus, according to one broad aspect of the invention it provides a composite connector device comprising a housing having first and second functional sides, the first functional side comprising at least two connection ports of at least first and second different types, and the second functional side comprising at least one connection port of the first type. The composite connector device further comprises at least one internal transmission channel passing inside the housing and connecting between the connection ports of said first type at, respectively, the first functional side and the second functional side of the housing. The composite connector device is thus configured as an adaptor for connection to an external device via the at least one connection port of the first type, and as a direct connector for connection to an external device via the at least one connection port of said at least second type.

In some embodiments, the composite connector device further comprises an additional transmission channel which by its one end is coupled to the connection port of the second type at the first functional side of the housing, passing through the housing and exiting the housing through the second functional side for connecting by its other free end to an external probe device.

In some embodiments, the connection port of the second type is configured as a RF signal connection port type.

In some embodiments, the connection port of the first type is a fluid communication port type and the internal transmission channel is a fluid communication channel. The at least one internal transmission channel may be configured for vacuum communication.

In some embodiments, the at least one internal transmission channel may be an integral part of the housing passing inside the housing between the housing's first and second functional sides. The internal transmission channel may comprise a pipe passing inside the housing and being interconnected between the connection port of the first type at the first functional side of the housing and the at least one connection port of the first type at the second functional side.

According to another broad aspect, the invention provides a probe device comprising a probe housing comprising at least one connection port mounted on the probe housing and configured for removable connection of the probe housing to at least one external transmission channel, and an integral transmission channel extending outside the probe housing, said integral transmission channel having a free end and being configured for removably connecting to an external connection port, thereby enabling the probe device to be disposable and to maintain sterile condition along said integral transmission channel.

In some embodiments, the at least one connection port mounted on the probe housing may be configured for RF transmission.
In some embodiments, the integral transmission channel extending outside the probe housing may be a fluid communication channel, specifically a vacuum communication channel.

The probe device may be configured for connecting to the composite connector device, such that the at least one connection port mounted on the probe housing is configured for connecting the probe device to at least one connection port of the second type at the first functional side of the composite connector, and the integral transmission channel extending outside the probe housing is configured for connecting to the at least one connection port of first type at the second functional side of the composite connector device.

In some embodiments, the probe device may be disposable and/or sterile.

In its yet further aspect, the invention provides a kit comprising the composite connector device as described above, and at least one probe device, each probe devices being maintained in a sterile package, to be used per demand by connection of the probe device to a console via the composite connector device, said connection comprising connecting the integral transmission channel extending outside the probe housing to the connection port of the first type at the second functional side of the probe device, and connecting the at least one connection port of the second type, at the first functional side of the composite connector device to the at least one connection port mounted on the probe housing.

The kit may further comprise at least one transmission channel configured for connection between the at least one connection port of the second type, at the first functional side of the composite connector device, and the at least one connection port mounted on the probe housing.

### BRIEF DESCRIPTION OF THE DRAWINGS

The patent or application file contains at least one drawing executed in color. Copies of this patent or patent application publication with color drawings will be provided by the Office upon request and payment of the necessary fee.

In order to better understand the subject matter that is disclosed herein and to exemplify how it may be carried out in practice, embodiments will now be described, by way of non-limiting examples only, with reference to the accompanying drawings, in which:

FIG. 1 is a schematic block diagram of a composite connector device of the invention, and a medical probe configured to be used with such composite connector;

FIG. 2 is a schematic block diagram of a composite connector device of the invention, an example of a transmission channel connected to a connection port at the first functional side of the composite connector and a medical probe configured to be used with such composite connector;

FIGS. 3A-3C illustrate an example of the configuration of the composite connector device of the invention;

FIGS. 4A-4D illustrate another example of the configuration of the composite connector device of the invention;

FIGS. 5A-5D illustrate an example of the configuration of the composite connector device of the invention connected to external transmission channels.

### DETAILED DESCRIPTION OF EMBODIMENTS

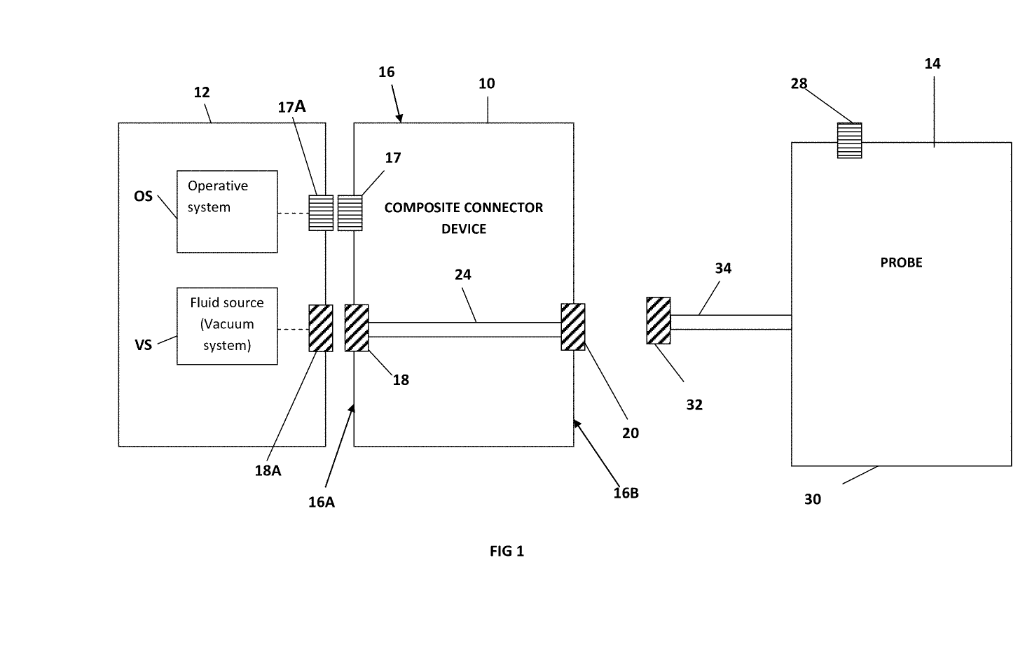

Reference is made to FIG. 1 which illustrates, by way of a block diagram, a non-limiting example of a composite connector device 10 of the invention. The connector device 10 is configured for connection between a console 12 (constituting a control system) and a medical probe device 14, in a manner providing at least two types of connection of the console 12 to the probe 14. The first type connection involves transmission channels configured for single-use connection, e.g. those transmission channels requiring maintaining sterility of the connected probe device, and the second type connection involves transmission channels configured for multi-use connection, e.g. those which do not require or affect sterility of the connected probe device(s). This allows selective use of adaptive coupling, e.g. by replacing the probe or replacing the connector device.

The composite connector 10 includes a housing 16 having first and second functional sides 16A and 16B, associated with respectively the console 12 and the probe 14. The first functional side 16A includes different connection port types, generally at least two such port types 17 and 18, both for connecting to the console 12 via respective connection ports 17A and 18A, and serving for respectively the multi-use and single-use connections to the probe 14. The second functional side 16B includes a connection port 20 (generally, at least one such connection port) of the first type (which is sometimes referred to herein as adaptor) for the single-use connection to the probe 14.

As also shown in the figure, the composite connector 10 further includes an internal transmission channel 24 which, by its one end is coupled to the connection port 18 of the first type on the first functional side 16A of the housing, passes inside the housing from the first functional side 16A and by its opposite end is coupled to the adaptor 20 (the connection port of the first type) at the second functional side 16B.

It should be noted that the above described novel composite connector 10, in accordance with the illustrating FIG. 1, is a simple construction of the composite connector 10. Generally, the composite connector device 10 may include a plurality of connection ports 18 of the first type at the first functional side 16A, a matching number of connection ports 20 at the second functional side 16B, and a matching number of internal transmission channels 24 interconnected between the connection ports 18 and 20. Further, the plurality of connection ports 18 and 20, intended for single-use/sterile connection, may have identical or different connecting properties. Similarly, the device connector 10 may include one or more connection ports 17 having identical or different connecting properties. For example, some of the connection ports 17 may be configured to transmit electromagnetic signals, and others may be configured to transmit acoustic energy, optical energy, etc. Additionally, the composite connector device 10 may be used with a plurality of probe devices simultaneously, such that it enables connection of the plurality of probe devices to a central console. Thus, generally, the connector device of the invention may be configured for concurrently connecting more than one probe device to the same console. The connector(s) 17 is/are constructed to enable connection of external transmission channel(s) to the composite connector device 10.

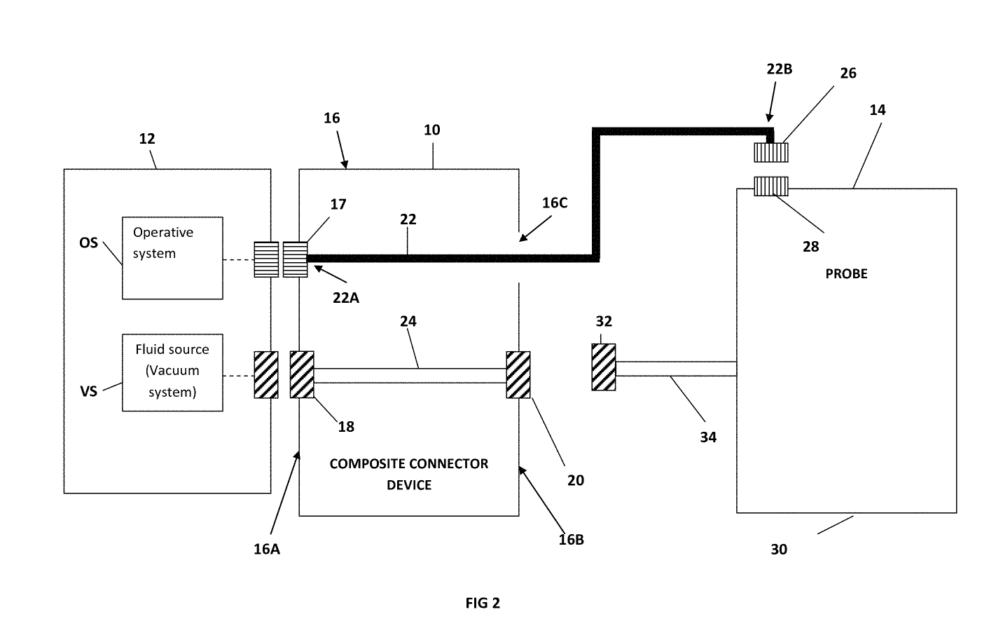

FIG. 2 illustrates, by way of a block diagram, an external transmission channel 22 which is by its one end 22A connected to the connection port 17 on the first functional side 16A, passes through the housing 16 from the side 16A and exits the housing through a respective aperture 16C on the second functional side 16B. The free end 22B of the external transmission channel 22 may be fitted with a connector 26 to facilitate/enable connection to a connection port 28 on a probe device 14.

Accordingly, the probe device 14 has a housing 30 and different-type connection ports 28 and 32 (generally, at least two such ports) for connection to the console 12 via the composite connector 10. One-type connection port 28 is configured for connection to the free end 22B of the external transmission channel 22, and the other-type connection port 32 (e.g. inlet port) is associated with one end of a transmission channel 34, which is integrated with the probe 14 at the other end. The connection port 32 is configured for connection to the adaptor 20 on the composite connector 10. The external transmission channel(s) 22 is/are occasionally termed herein as the “operative channel(s)” and the transmission channel 34 integrated with the probe 14 is termed herein as the “attachment channel”. The “attachment channel” 34 is typically a fluid connection channel, such as by suction (vacuum), while the “operative channel(s)” is/are typically configured for applying one or more external fields to the tissue and/or detecting such field(s) from the tissue. Such external field may be electromagnetic radiation, RF, microwave, acoustic, optical, etc. The “operative channel(s)” may also include digital and/or analog, transmission channels for command and control signal communication between the console and the probe.

Such configuration of the composite connector 10 facilitates use of medical devices requiring sterile connection to the tissue/body which in turn requires sterile-condition connection to a vacuum system VS in the console, while at the same time enabling connection of other operative systems OS for measuring tissue properties and/or treating tissue. The attachment transmission channel 34 may thus be configured for being removably connected to the adaptor 20, enabling the probe device to be disposable and to be kept in sterile condition.

Thus, when the probe device 14 is to be in operation, i.e. to be in contact with a tissue and to be operable by the console 12, the probe 14 is connected to the console 12 via the composite connector 10. To this end, the free end 22B of the external transmission channel 22 is connected via connector 26 to the connection port 28 of the probe 14, and the free end 32 of the probe transmission channel 34 is connected to the adaptor 20 which is associated with (e.g. integral with) the fluid transmission channel 24. Thus, the probe 14 is connected to the console 12 via the composite connector 10 using the “operative channels” passing through the composite connector 10, and using the adaptor 20 to connect to the “attachment channel” 34 integral with the probe 14.

The composite connector 10 of the invention thus provides for connection between the console 12 and probe 14 via the operative transmission channel(s) passing through the composite connector 10, and via the adaptor 20 (for fluid-type communication channel(s)) mounted on the composite connector 10.

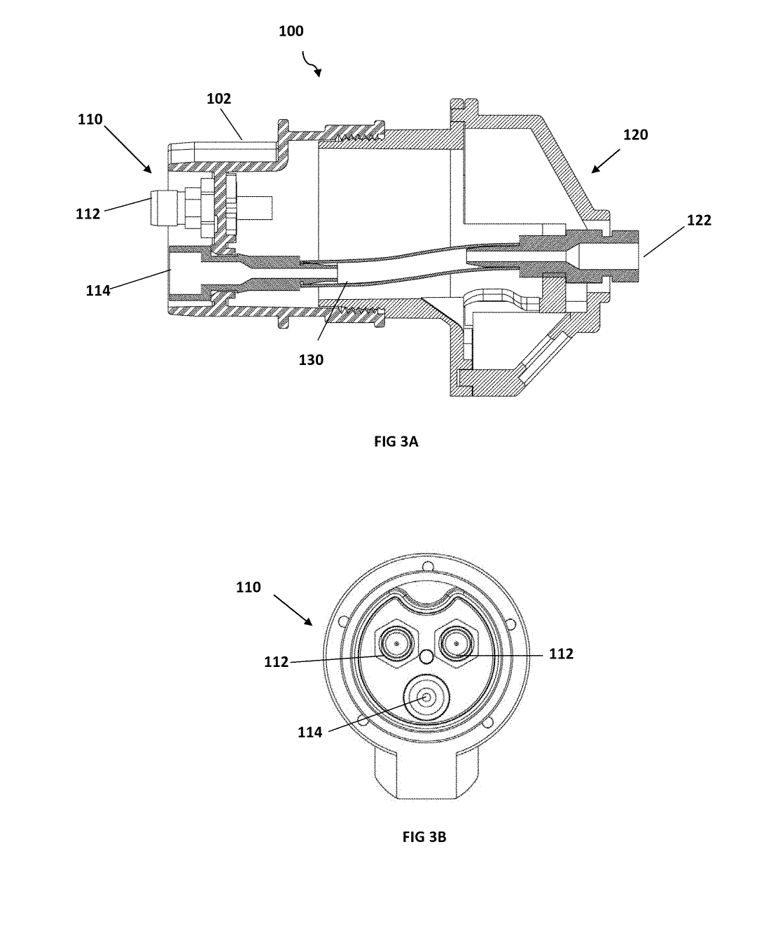

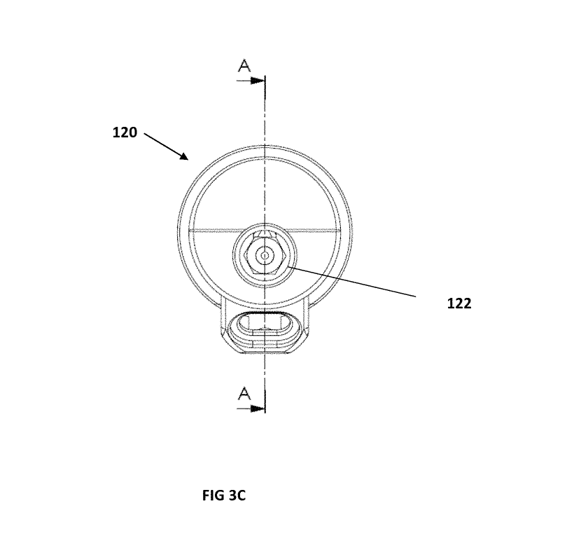

Reference is made to FIGS. 3A-3C illustrating schematically an exemplary configuration of the composite connector device of the invention. The figures show different side views of the composite connector device.

As shown, FIG. 3A is a cross sectional side view of a composite connector device, generally at 100. The connector device 100 has a housing 102 having a first functional side 110 and a second functional side 120. The first functional side 110 includes two different connection port types 112 and 114 for connecting to an external console (not shown here).

It should be noted that the number of the different connection port types may be more than two. Also, it should be understood that there might be more than one port from each type of connection port, i.e. a plurality of connection ports of the same type or of different types.

In this specific non limiting example, as will be further detailed below, the first functional side has one port of a first type 114 and two ports of a second type 112. The second functional side 120 includes at least one connector 122 configured for adaptively connecting to a connection port of an external transmission channel (the “attachment channel”) which typically, but not necessarily, forms an integral part of and extends from an external probe device (not shown).

The connection port 114 at the first functional side 110 is associated with a fluid/vacuum transmission system (which is typically found inside the console) and is coupled to an internal transmission channel 130 inside the housing 102. The transmission channel 130 extends between the connection port 114 at the first functional side 110 and the at least one connector 122 at the second functional side 120. The combination of the connection port 114 at the first functional side 110, the channel 130 connecting connector 114 and connector 122, and the connector 122 at the second functional side 120, together constitute an adaptor for a fluid/vacuum communication channel. This is also exemplified in FIG. 2, where the combination 18, 24, and 20, form an adaptor between the console 12 and channel 34 at the probe device 14 side.

As described above, the fluid communication/transmission system, as referred to herein in the description, is preferably a vacuum system or a negative pressure system applied from the console, via the composite connector 100 and the probe, to the examined tissue of the patient. This negative pressure may be used, for example, in order to enable and ensure an effective coupling between the probe and the examined/treated tissue. It should be noted, that in this example the vacuum channel 130 is a standalone structure/pipe. This structure/pipe is configured for minimizing loss of pressure. It may be made from different kinds of materials, such as elastic/resilient or rigid materials.

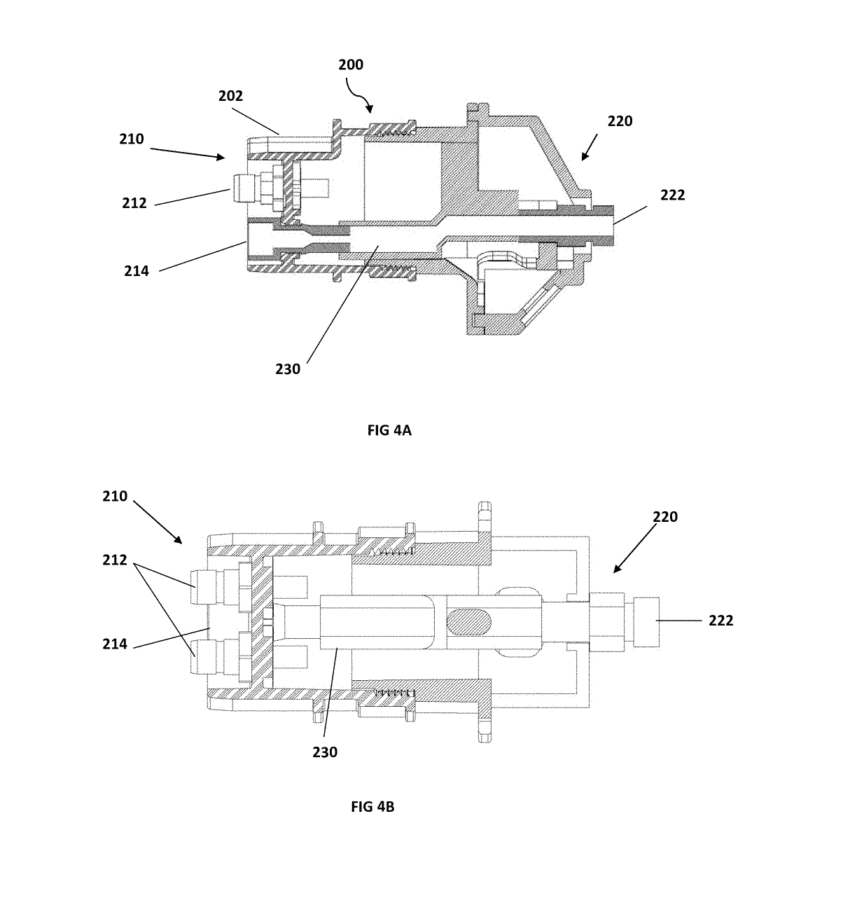

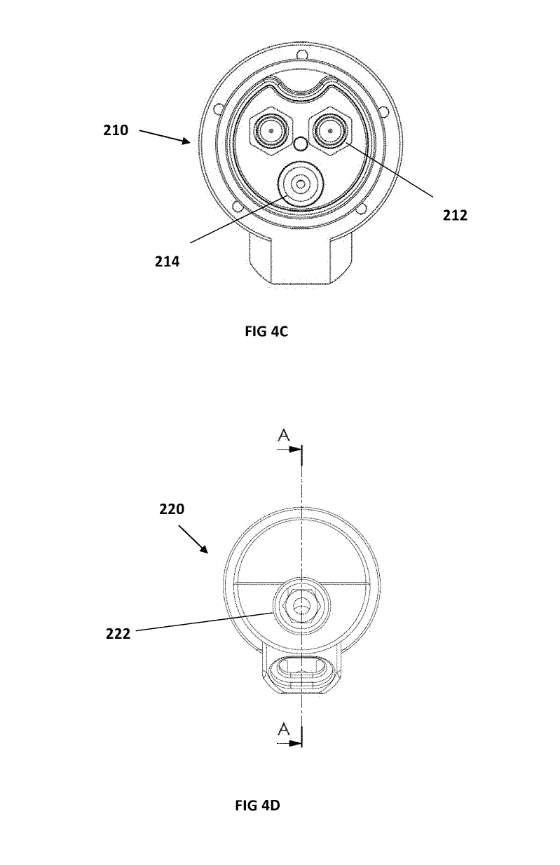

In some embodiments, the fluid communication/transmission system may also be configured for applying positive pressure, and for applying both negative and positive pressure. Generally, the internal transmission channel 130 may be formed as an integral part of the composite connector device of the invention, i.e. formed as a path between the parts that constitute the composite connector, running through the composite connector, as will be further described below with reference to FIGS. 4A-4C; alternatively, the internal transmission channel is formed, as exemplified above, may be a standalone structure/pipe passing inside the composite connector's housing.

The at least one connector 122 is configured for connecting to an external probe channel (the “attachment channel”, transmission channel 34 in FIG. 2) extending from the probe device (14 in FIG. 2) through a connection port/end 32 of the transmission channel 34.

The configuration of the composite connector of the invention thus provides for selectively coupling (adaptive coupling) the internal and external vacuum channels (24 and 34 in FIG. 2). This enables the external vacuum channel 34 (e.g. together with the associated probe) to be disposable and accordingly to be kept sterile as the case may be.

FIGS. 3B and 3C show the first and second functional sides 110 and 120, respectively, with the connection ports 112 and 114 at the first side, and the connector 122 at the second side.

Reference is made to FIGS. 4A-4D illustrating another specific but not limiting example of the configuration of the composite connector device 200 according to the invention. In this example, and for the sake of simplicity, all numbers referring to the same functional part as in the first embodiment of FIGS. 3A-3C are stepped by 100.

Specifically, in FIG. 4A, a sectional side view of a composite connector 200 is shown being configured according to the invention. The connector 200 has a housing 202 which has two functional sides 210 and 220. The first functional side 210 has connection ports 212 and 214, for transmission of RF (or other energy(ies), and/or signal command and control, as explained above) and transmission of fluid (vacuum) communication, respectively. The housing 202 is configured to be attached to (mounted on) a console unit at the first functional side 210. The second functional side 220 serves for connection with a medical probe device. The second functional side 220 includes at least one connector 222 for connecting to an external vacuum channel (the “attachment channel”) which is usually integral with the probe device.

The connection ports of type 212 at the first functional side 210 are configured for permanent coupling with external transmission channels which may pass outside or through the housing 202. The transmission channels may be configured as an RF connection, an optical fiber connection or another kind of connection. The channels are, by their one end, connected to the connection ports, and are by their opposite free end connected to the external probe device.

The connection port 214 at the first functional side 210 is associated with a fluid/vacuum system (which is typically found inside the console) and is coupled to an internal transmission channel 230 (e.g., a vacuum channel) inside the housing 202. It should be noted that the vacuum channel 230, in this specific non limiting example, is an integral part of the housing 202. That is, it is formed by the mating of the 3 sub-assemblies of the housing 202. This is different from the configuration presented in FIGS. 3A-3C, where the vacuum channel 130 is constructed as a tube connecting connector 114 and connector 122. The vacuum channel 230 extends between the connection port 214 at the first functional side 210 and at least one connector 222 at the second functional side 220. The at least one connector 222 is configured for connecting to an external vacuum channel (the “attachment channel” extending from the probe) through a connection port provided at the external vacuum channel. As appreciated, the main difference between the first and second embodiments of the composite connectors 100 and 200, is that the vacuum channel in the connector 200 is an integral channel/conduit built inside the housing 202, unlike the independent internal transmission tube 130 used in the connector 100. This means, inter alia, that a smaller number of parts are used to manufacture the composite connector 200, and that the assembly of the composite connector 200 is more streamlined than that of the composite connector 100.

FIGS. 4B-4D show the top side view, and the views from the first functional side 210 and second functional side 220 of the connector device 200, respectively. In FIG. 4B, it can be seen again that the vacuum channel 230 is formed integrally by the different parts constructing the connector device 200. FIGS. 4C and 4D show the first and second functional sides 210 and 220, respectively, with the connection ports 212 and 214 at the first side, and the connector 222 at the second side.

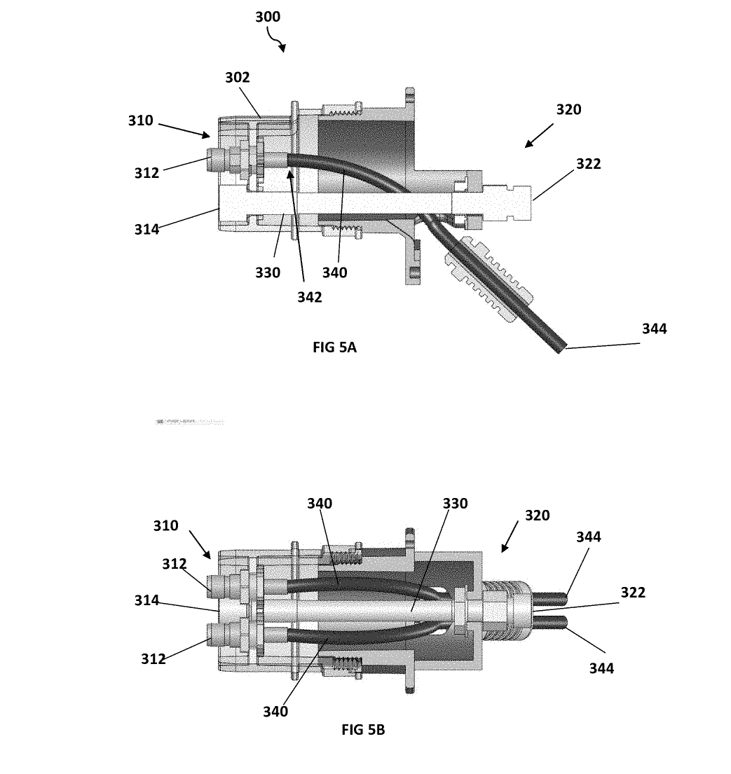

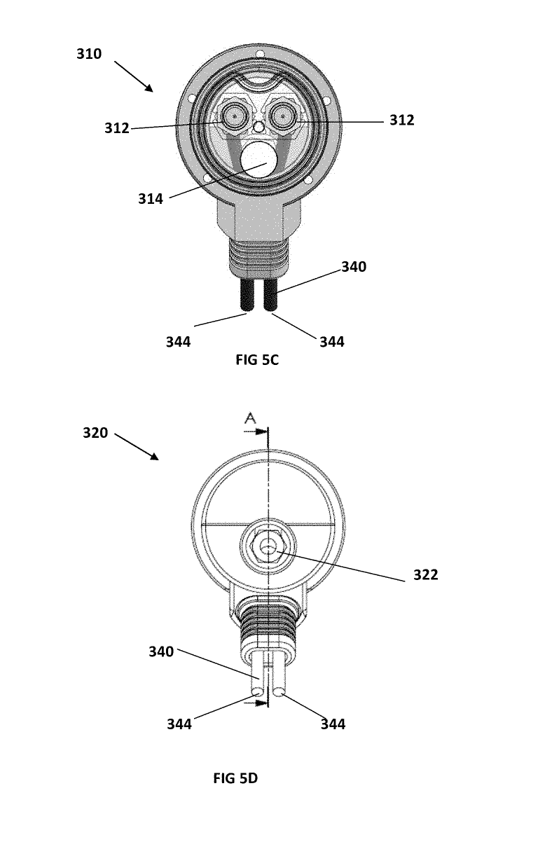

Reference is made to FIGS. 5A-5D exemplifying configuration of the composite connector device of the invention fitted with external transmission channel 340, which may be used with the connector device 100, 200 as well as with other connector devices configured utilizing the principles of the present invention. In this example, and for the sake of simplicity, all numbers referring to the same functional part as in the first embodiment of FIGS. 3A-3C are stepped by 200. As shown in FIG. 5A, the connection ports 312 of the second type at the first functional side 310 are configured for permanent coupling with external transmission channels 340 (two connectors and two external channels are exemplified as will be clearly shown in FIG. 5B). The channels 340 are, by their one end 342 connected to the connection ports 312, pass through the housing 302 from the first functional side 310 and exit the housing 302 through the second functional side 320 for connecting by their other end 344 to the external probe device. The external transmission channels 340 may be configured for RF connection (e.g. coaxial cable), and/or for optical connection (optical guide/fiber), as well as any other suitable type of operative connection. In this specific example, the operative connection is referred to as RF connection. However such operative connection should be interpreted broadly and it is by no means limited to this specific example.

Reference is made to FIG. 5B showing the composite connector 300 from the top side. As can be seen more clearly, the device of the present embodiment has three connection ports on the first functional side 310. Two connection ports 312 are of the second port type, associated with operative transmission channels of one or two types, e.g. RF connection ports. It should be noted, however, that the two connection ports 312 may provide for different operative transmissions, such as one for RF and another for optical transmission, etc. In this case, the two connection ports 312 will be of different connection port types. The third connection port 314 is of the first, different, port type, associated with the internal transmission channel 330 for connecting to the vacuum system at the console side. The internal transmission channel 330 is terminated at the second functional side 320 with a port 322 (of the first type) which is aimed and aimed to receive a fluid transmission channel from an external probe.

It should also be noted that in some embodiments, the operative transmission channels 340 configured for permanent coupling to the composite connector 300 may be integral with the composite connector 300 and are connectable to the corresponding channels of the console via the connection ports 312. Thus, the present invention provides for effective and simple connection between a medical probe and associated control unit/system. The composite connector device of the invention allows for maintaining sterile conditions, when needed, of a certain part of the probe being connected to the control unit via the composite connector.

1. A composite connector device comprising:
a housing having first and second functional sides, the first functional side comprising at least two connection ports of at least first and second different types, and the second functional side comprising at least one connection port of the first type,
at least one internal transmission channel passing inside the housing and connecting between the connection ports of said first type at respectively the first functional side and the second functional side of the housing;
the composite connector device being thereby configured as an adaptor for connection to an external device via the at least one connection port of the first type, and as a connector for connection to an external device via the at least one connection port of said at least second type.

2. The composite connector device according to claim 1, further comprising an additional transmission channel, said additional transmission channel by its one end being coupled to the connection port of the second type at the first functional side of the housing, and passing through the housing and exiting the housing through the second functional side for connecting by its other free end to an external probe device;

3. The composite connector device according to claim 1, wherein the connection port of said second type is configured as a RF signal connection port type.

4. The composite connector device according to claim 1, wherein the connection port of said first type is a fluid communication port type and said internal transmission channel is a fluid communication channel.

5. The composite connector device according to claim 4, wherein said at least one internal transmission channel is configured for vacuum communication.

6. The composite connector device according to claim 1, wherein said at least one internal transmission channel is an integral part of the housing passing inside the housing between its first and second functional sides.

7. The composite connector device according to claim 1, wherein said at least one internal transmission channel comprises a pipe passing inside the housing and being interconnected between said connection port of said first type at the first functional side of the housing and said at least one connection port of the first type at the second functional side

8. A probe device comprising:
a probe housing comprising at least one connection port mounted on the probe housing and configured for removable connection of the probe housing to at least one external transmission channel, and an integral transmission channel extending outside the probe housing, said integral transmission channel having a free end being configured for removably connecting to an external connection port, thereby enabling the probe device to be disposable and to maintain sterile condition along said integral transmission channel.

9. The probe device according to claim 8, wherein said at least one connection port is configured for RF transmission.

10. The probe device according to claim 8, wherein said integral transmission channel is a fluid communication channel.

11. The probe device according to claim 10, wherein said integral transmission channel is configured as a vacuum communication channel.

12. The probe device according to claim 8, being configured for connecting to a composite connector device, wherein:
said composite connector device comprises:
a housing having first and second functional sides, the first functional side comprising at least two connection ports of at least first and second different types, and the second functional side comprising at least one connection port of the first type; and
at least one internal transmission channel passing inside the housing and connecting between the connection ports of said first type at respectively the first functional side and the second functional side of the housing;
said at least one connection port mounted on the probe housing being configured for connecting the probe device to at least one connection port of said second type at the first functional side of the composite connector, and said integral transmission channel extending outside the probe housing is configured for connecting to said at least one connection port of first type at the second functional side of the composite connector device.

13. The probe device according to claim 8 being disposable.

14. The probe device according to claim 8 being sterile.

15. A kit comprising:
a composite connector device, comprising:
a housing having first and second functional sides, the first functional side comprising at least two connection ports of at least first and second different types, and the second functional side comprising at least one connection port of the first type,
at least one internal transmission channel passing inside the housing and connecting between the connection ports of said first type at respectively the first functional side and the second functional side of the housing;
a set of at least one probe device, each of the at least one probe devices comprising:
a probe housing comprising at least one connection port mounted on the probe housing and configured for removable connection of the probe housing to at least one external transmission channel, and an integral transmission channel extending outside the probe housing, said integral transmission channel having a free end being configured for removably connecting to an external connection port, thereby enabling the probe device to be disposable and to maintain sterile condition along said integral transmission channel,
each of the at least one probe devices being maintained in a sterile package, to be used per demand by connection of the probe device to a console via the composite connector device, said connection comprising connecting said integral transmission channel extending outside the probe housing to said connection port of the first type at the second functional side of the probe device, and connecting said at least one connection port of the second type, at the first functional side of the composite connector device to said at least one connection port mounted on the probe housing.

16. The kit according to claim 15 further comprising at least one transmission channel configured for connection between said at least one connection port of the second type, at the first functional side of the composite connector device, and said at least one connection port mounted on the probe housing.
